(19) United States
(12) Patent Application Publication
(10) Pub. No.: US 2004/0223521 A1
(43) Pub. Date: Nov. 11, 2004

(54) Method and a device for distributed Raman amplification in an optical fiber by optical signals with different wavelengths and different polarizations

(75) Inventors: Eric Brandon, Paris (FR); Laurent Labrunie, Paris (FR)

Correspondence Address: SUGHRUE MION, PLLC, Suite800, 2100 Pennsylvania Avenue, N.W., Washington, DC, 20037-3213, US

(73) Assignee: Alcatel

(21) Appl. No.: 10/837,644

(22) Filed: May 4, 2004

(30) Foreign Application Priority Data
May 6, 2003 (FR) 03 05 479

(51) Int. Cl. H01S 3/30

(52) U.S. Cl. 372/3; 372/6; 372/70

(57) ABSTRACT

A device (D) for amplifying optical signals is connected to an optical fiber (3) conveying an optical data signal and delivers into said optical fiber first and second optical pump signals at different wavelengths for amplifying the data signal by stimulated Raman scattering. Each pump signal comprises two pump signal components whose polarizations are mutually orthogonal. Moreover, the amplification device D comprises a control module 14 for delivering alternately a first combined pump signal and a second combined pump signal, the first combined pump signal comprising a component of the first pump signal and a component of the second pump signal that have mutually orthogonal polarizations and the second combined pump signal comprising the other component of the first pump signal and the other component of the second pump signal.

The field of the invention is that of transmitting optical signals and more particularly that of amplifying signals in an optical fiber by the distributed Raman effect.

Amplification by the distributed Raman effect is a technique that is well known in the art for in situ amplification of optical data signals in an optical fiber, for example between distant sender and receiver stations. One implementation of the technique injects into an optical fiber first and second pump signals copropagating or contrapropagating with respect to the signals to be amplified, the first and second pump signals having first and second wavelengths shorter than those of the data signals and being adapted, by first order stimulated Raman scattering (SRS), to transfer a portion of their power (“pump power”) to the data signals.

Two pump signals injected in this way into an optical fiber are able to amplify a data signal, in particular a wavelength division multiplex signal, with wavelengths occupying a bandwidth of approximately 30 nanometres (nm). A wider band may be envisaged if more than two pump signals with different wavelengths are used.

The person skilled in the art knows that the efficiency of distributed Raman amplification over the whole length of the fiber is reduced because of stimulated Raman scattering between the pump signals, which depletes energy levels associated with shorter wavelengths to the benefit of energy levels associated with longer wavelengths. This reduced efficiency is accentuated by the attenuation intrinsic to optical fibers (especially at the wavelengths of the pump signals), which reduces the distance over which the pump signals and the data signals interact.

One proposed solution to this problem is to modulate the injection of the pump signals into the optical fiber so that they are not able to interact with each other. It is also possible to inject into the optical fiber an additional pump signal, either contrapropagating or copropagating with respect to the data signals, at a third wavelength and adapted to amplify the other two pump signals by second order stimulated Raman scattering.

That solution is certainly beneficial, but it is based on the use of unpolarized pump signals delivered by Fiber Raman lasers, for example. Although such lasers can comply with the mean Raman amplification time, they are unable to achieve sufficient amplification efficiency during the short time periods in which they are not authorized to deliver their pump signals.

An object of the invention is therefore to improve on the above situation.

To this end, the invention proposes a method dedicated to optical amplification by stimulated Raman scattering of the power of optical data signals travelling in a selected direction in an optical fiber, such amplification using optical pump signals at different wavelengths.

The method is characterized in that: there is provided a first optical pump signal comprising two components having respective and mutually orthogonal first and second polarizations; there is additionally provided a second optical pump signal comprising two components having the first polarization and the second polarization, respectively; and a first combined pump signal and a second combined pump signal are injected alternately into the optical fiber, the first combined pump signal comprising a component of the first optical pump signal and a component of the second optical pump signal that have mutually orthogonal polarizations and the second combined pump signal comprising the other component of the first optical pump signal and the other component of the second optical pump signal.

Because they are orthogonally polarized, the two pump wavelengths coexist simultaneously and continuously in the optical fiber without interacting with each other.

The injection times of the first and second pump signals are preferably substantially equal.

Moreover, in order not to degrade the traffic in the optical fiber, the alternating injection is preferably effected at a frequency greater than or equal to 1 kilohertz (kHz).

Furthermore, the combined pump signals are preferably contrapropagating with respect to the data signals.

The invention also provides a device for amplifying optical data signals, the device being adapted to provide, for an optical fiber conveying an optical data signal, first and second pump signals at wavelengths adapted to amplify the optical data signal by first order stimulated Raman scattering.

The device is characterized by a power supply module for supplying two components of the first pump signal having respective and mutually orthogonal first and second polarizations and two components of the second pump signal having said first and second polarizations, respectively, and a control module adapted to deliver a first combined pump signal and a second combined pump signal alternately into the optical fiber, the first combined pump signal comprising a component of the first pump signal and a component of the second pump signal that have mutually orthogonal polarizations and the second combined pump signal comprising the other component of the first pump signal and the other component of the second pump signal.

The control module is preferably adapted to deliver the combined pump signals for substantially equal times.

Moreover, the control module is preferably adapted to deliver the pump signals alternately at a frequency greater than or equal to 1 kHz.

Furthermore, the device is preferably adapted to deliver contrapropagating combined pump signals with respect to the data signals.

The power supply module is preferably of the diode type able to deliver pump signals having linear polarizations.

An advantageous embodiment of the optical signal amplification device comprises:

a first polarization multiplexer adapted to be supplied continuously by the power supply submodules supplying the two components of the first pump signal and to combine said components of the first pump signal to deliver one or the other of said components of the first pump signal alternately to an output on the instructions of said control module,

a second polarization multiplexer adapted to be supplied continuously by the power supply submodules supplying the two components of the second pump signal and to combine said components of the second pump signal to deliver one or the other of said components of the second pump signal alternately to an output on the instructions of said control module, and

a wavelength division multiplexer adapted to combine the pump signal components delivered to the outputs of said first polarization multiplexer and said second polarization multiplexer.

According to whether or not it is integrated into a sender or receiver station coupled to an optical fiber, the device of the invention includes or does not include a coupler for injecting the first and second pump signals into the optical fiber.

The invention further provides a sender station equipped with a device of the type described hereinabove and a receiver station equipped with a device of the type described hereinabove.

The method, the device, and the sender and receiver stations of the invention find a particularly beneficial, although not exclusive, application in the field of telecommunications and more particularly in the field of transmission systems with and without optical amplifiers (such as repeaters, for example).

Other features and advantages of the invention will become apparent on reading the following detailed description and examining the appended drawings, in which:

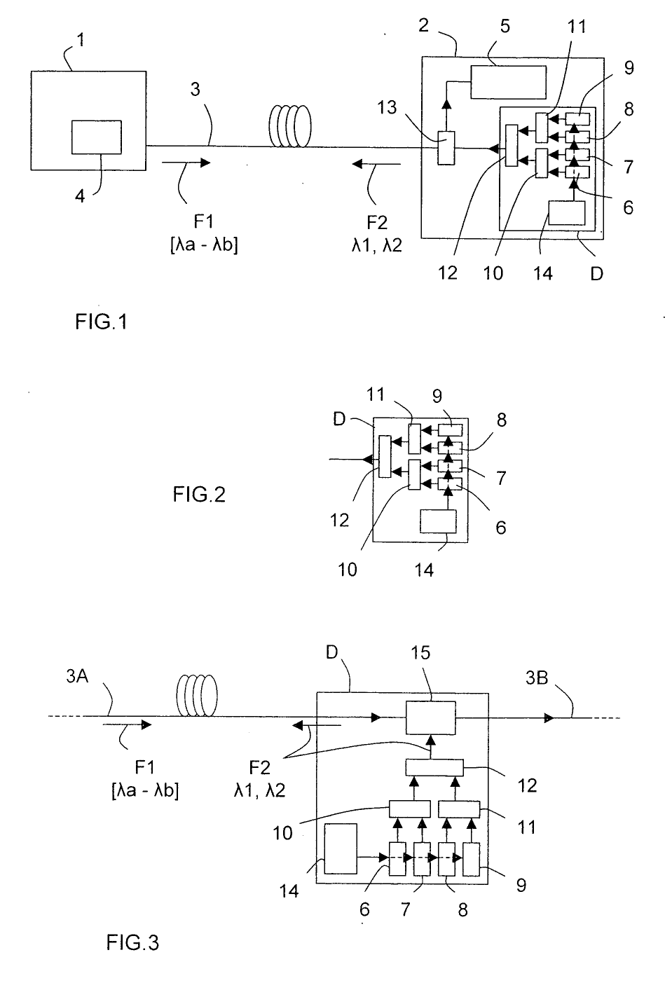

FIG. 1 depicts diagrammatically a first embodiment of a device of the invention adapted to a first type of installation for transmitting an optical data signal;

FIG. 2 shows in more detail the first embodiment of the device shown in FIG. 1;

FIG. 3 depicts diagrammatically a second embodiment of a device of the invention adapted to a second type of installation for transmitting an optical data signal; and

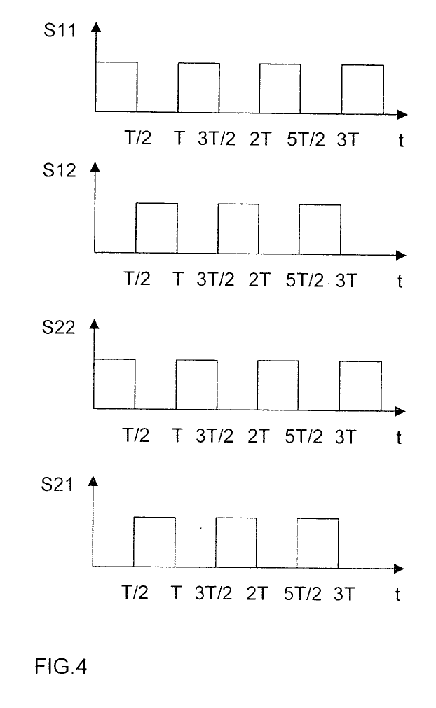

FIG. 4 depicts in the form of superposed timing diagrams one example of combination in accordance with the invention of four types of pump signal components.

The appended drawings constitute part of the description of the invention and may, if necessary, contribute to the definition of the invention.

The invention is dedicated to the amplification of data signals flowing in an optical fiber by first order stimulated Raman scattering (SRS) using pump signals at different wavelengths.

An amplification device D of the invention is described first with reference to FIGS. 1 and 2, and is included in an installation, for example a telecommunication installation, adapted to transmit an optical data signal without using optical amplifiers (signal repeaters or regenerators, for example of the 3R type). This kind of installation may be used in the context of submarine or terrestrial transmission, for example.

In this example the installation comprises a station 1 for transmitting optical signals connected by an optical fiber 3 to a distant station 2 for receiving optical signals.

The transmission station 1 includes a transmission module 4 for delivering into the optical fiber 3 an optical data signal representative of data to be transmitted and having wavelengths in a selected range [λa-λb]. For example, the data signal that is sent is a wavelength division multiplex signal with wavelengths in the range [1545 nm-1560 nm] or [1530 nm-1562 nm].

Once it has been injected into the optical fiber 3, the data signal propagates in the direction of the receiver station 2 (as shown by the arrow F1). The receiver station has a receiver module 5 for analyzing the received data signal in order to use it or to forward it to one or more other stations of the installation.

In this example, the receiver station 2 is equipped with a signal amplification device D of the invention for amplifying the data signal, where possible in a homogeneous manner over a great length of optical fiber 3, for example a length of several tens of kilometres (this kind of amplification is referred to as distributed amplification).

The amplification device D comprises a power supply module consisting in this example of four submodules 6 to 9.

The first submodule 6 is adapted to deliver a first pump signal S1 at a wavelength λ1 that is lower than the wavelengths [λa-λb] of the data signal and having polarization that is preferably linear.

The second submodule 7 is adapted to deliver a first pump signal S12 at the wavelength λ1 and having polarization that is preferably linear.

The third submodule 8 is adapted to deliver a second pump signal S21 at a wavelength λ2 that is lower than the wavelengths [λa-λb] of the data signal but higher than that (λ1) of the first pump signal and preferably having linear polarization.

The fourth submodule 9 is adapted to deliver a second pump signal S22 at the wavelength λ2 and preferably having linear polarization.

The wavelengths λ1 and λ2 are chosen to optimize the coupling between the pump signals and the data signals in the optical fiber 3. The expression “to optimize the coupling” means to induce optimum amplification of the data signals by first order stimulated Raman scattering. This first order amplification mechanism is described, for example, in the paper “Properties of fiber Raman amplifiers and their applicability to digital optical communication systems”, Aoki, Journal of lightwave technology, July 1988, Vol.6, No. 7.

For example, if the wavelengths [λa-λb] of the data signals are substantially contained within the range [1530 nm-1562 nm], the pump signals may have wavelength λ1 and λ2 approximately equal to 1425nm and 1455nm, respectively.

Each submodule 6 to 9 is preferably equipped with a diode (not shown) delivering source light at the wavelength λ1 or λ2. The diodes are preferably standard semiconductor laser diodes of the type used for doped fiber amplification (for example erbium-doped fiber amplification).

The first and second submodules 6 and 7 are coupled to a first polarization multiplexer (polarization combiner) 10 of the amplification device D to supply it with the two components S11 and S12 of the first pump signal at the wavelength λ1. Similarly, the third and fourth submodules 8 and 9 are coupled to a second polarization multiplexer (polarization combiner) 11 of the amplification device D to supply it with the two components S21 and S22 of the second pump signal at the wavelength λ2.

The first polarization multiplexer 10 is adapted to combine the components of the first pump signal delivered by the first and second submodules 6 and 7 in such a manner as to deliver to an output the component S11 having a selected first polarization and the component S12 having a second polarization perpendicular to the selected first polarization.

Similarly, the second polarization multiplexer 11 is adapted to combine the components of the second pump signal delivered by the third and fourth submodules 8 and 9 in such a manner as to deliver to an output the component S21 having the selected first polarization and the component S22 having the second polarization perpendicular to the selected first polarization.

The outputs of the polarization multiplexers 10 and 11 supply orthogonally polarized pump signals to a wavelength division multiplexer 12 of the amplification device D.

In this example, the wavelength division multiplexer 12 has an output which supplies a routing device 13 of the receiver station 2, such as an optical circulator, that is also connected to the fiber 3 and to the receiver module 5 (or to an amplifier if there is one).

The amplification device D further comprises a control module 14 adapted to have the wavelength division multiplexer 12 deliver alternately a combined pump signal comprising the component S11 of the first pump signal having the first polarization and the component S22 of the second pump signal having the second polarization and another combined pump signal comprising the component S12 of the first pump signal having the second polarization and the component S21 of the second pump signal having the first polarization.

To achieve this, at least two solutions may be envisaged. A first solution, depicted in FIGS. 1 and 2, consists in controlling the four submodules 6 to 9 of the amplification device D with the aid of the control module 14.

To be more precise, the control module 14 is configured to modulate the respective powers of the four submodules 6 to 9 so that they deliver the combined pump signals alternately.

Consequently, the first polarization multiplexer 10 is supplied alternately either by the first submodule 6 with the component S11 of the first pump signal or by the second submodule 7 with the component S12 of the first pump signal, for example, while at the same time the second polarization multiplexer 11 is supplied alternately either by the third submodule 8 with the component S21 of the second pump signal or by the fourth submodule 9 with the component S22 of the second pump signal, for example.

In this example, the polarization multiplexers 10 and 11 are passive components.

The polarization multiplexers 10 and 11 preferably deliver their signals synchronously. Consequently, the alternation frequencies of the signals delivered by the polarization multiplexers 10 and 11 are substantially identical. FIG. 4 depicts one example of combining timing diagrams for the components of the pump signals delivered by the polarization multiplexers 10 and 11.

In this example of periodic alternation with period T, during a first time interval [0, T/2] equal to a half-period T/2, the polarization multiplexers 10 and 11 deliver, substantially simultaneously, the component S11 of the first pump signal having the first polarization and the component S22 of the second pump signal having the second polarization, respectively. Then, during a second time interval [T/2, T] equal to a half-period T/2, the polarization multiplexers 10 and 11 deliver, substantially simultaneously, the component S12 of the first pump signal having the second polarization and the component S21 of the second pump signal having the first polarization, respectively. Then, during a third time interval [T, 3T/2] equal to a half-period T/2, the polarization multiplexers 10 and 11 again deliver, substantially simultaneously, the same pump signal components as were delivered during the first time interval. Then, during a fourth time interval [3T/2, 2T] equal to a half-period T/2, the polarization multiplexers 10 and 11 again deliver, substantially simultaneously, the same pump signal components as were delivered during the second time interval. The operation of the device D continues periodically in this manner.

In each first half-period of duration T/2, the wavelength division multiplexer 12 is therefore supplied by the polarization multiplexers 10 and 11 with the pump signal components S11 and S22 so that it may combine them and deliver to its output a first combined pump signal representing the superposition of the components S11 and S22. Similarly, during each second half-period of duration T/2, the wavelength division multiplexer 12 is fed by the polarization multiplexers 10 and 11 with pump signal components S12 and S21 so that it may combine them and deliver to its output a second combined pump signal representing the superposition of the components S12 and S21.

Thus the wavelength division multiplexer 12 may supply the optical fiber 3 either with the first combined pump signal or with the second combined pump signal, alternately and via the circulator 13,. In this way, because of their orthogonal polarizations, the two pump wavelengths λ1 and λ2 may coexist simultaneously and continuously in the optical fiber 3 without interacting with each other. In other words, there is no or virtually no depletion of high energy levels associated with the wavelength λ1 to the benefit of lower energy levels associated with the wavelength λ2.

Because the amplification device D is installed in the receiver station 2, the first and second combined pump signals injected by the circulator 13 are contrapropagating with respect to the data signals (as indicated by the arrow F2 in FIG. 1).

It is important to note that other combinations of timing diagrams may be envisaged. Thus dividing each period T into two portions with different durations may be envisaged. Using overlapping pulses may also be envisaged if the control electronics are not fast enough, or using pulses having a duration less than a half-period to minimize interaction between the pumps, or using a modulation depth of less than 100% to avoid turning the laser diodes off completely.

In order not to degrade traffic in the optical fiber 3, the alternation frequency is preferably greater than or equal to 1 kHz, and more preferably of the order of 500 kHz.

A second solution (not shown) is to supply the polarization multiplexers 10 and 11 continuously with the pump signal components delivered by the four submodules 6 to 9. The polarization multiplexers 10 and 11 are then of the active type and controlled conjointly by the control module 14 to deliver alternately and in opposition pump signal components having either the first polarization or the second polarization.

To be more precise, the first polarization multiplexer 10 delivers alternately a component S11 of the first pump signal having the first polarization and a component S12 of the first pump signal having the second polarization and the second polarization multiplexer 11 delivers alternately a component S22 of the second pump signal having the second polarization and a component S21 of the second pump signal having the first polarization.

Otherwise, the operation of the amplification device D is similar to that described above with reference to FIGS. 1, 2 and 4.

Another embodiment of an amplification device D of the invention is described next with reference to FIG. 3. In this embodiment, the amplification device D is adapted for use in an installation including an optical amplifier (signal repeater or regenerator, for example of the 3R type) and adapted to transmit optical data signals, for example a telecommunication installation. This kind of installation may be used in the context of submarine or terrestrial transmission, for example.

In this example the installation is shown only by two optical fiber portions 3A and 3B, which may be connected to a sender station 1 or a receiver station 2.

This embodiment of the device D has the same structure as that described above with reference to FIGS. 1 and 2, but additionally comprises a coupler 15 for coupling the device D to the two optical fiber portions 3A and 3B, which are connected to other amplification devices D or to sender and/or receiver stations (where applicable equipped with an amplification device D).

The coupler 15 is also connected to the wavelength division multiplexer 12 which supplies it with pump signal components. In other words, the coupler 15 executes part of the function of the circulator 13 shown in FIG. 1.

The operation of this amplification device D is similar to that described above with reference to FIG. 1.

Moreover, a variant (not shown) of the amplification device D in which the polarization multiplexers are of the active type is equally feasible in this example.

It is important to note that, to amplify broadband data signals, the amplification device D of the invention may be adapted to deliver combinations of pump signals having more than two different wavelengths, for example three different wavelengths.

In this case, the two wavelengths that are liable to interact most strongly because of stimulated Raman scattering are determined and the alternation described above is applied to the second signals at those two wavelengths. The pump signals at the third wavelength and interacting less strongly with the other two pump signals are then supplied continuously to the wavelength multiplexer 12.

The invention also provides a method dedicated to optical amplification by first order stimulated Raman scattering of an optical data signal in a selected direction in an optical fiber 3 using two pump signals at different wavelengths.

The above method may be implemented by one of the installations described hereinabove or one of the amplification devices D, whether it is installed in a receiver station 2 or in a sender station 1 or is fitted directly to an optical fiber 3. The main and optional functions and subfunctions executed by the steps of the method being substantially identical to those executed by the various means constituting the amplification device, there are summarized hereinafter only the steps for implementing the main functions of the method of the invention.

In that method, a first pump signal and a second pump signal each have two pump signal components whose polarizations are mutually orthogonal and amplification is effected by alternating a first combined pump signal and a second combined pump signal, the first combined pump signal comprising a component S11 of the first pump signal having the first polarization and a component S22 of the second pump signal having the second polarization and the second combined pump signal comprising a component S12 of the first pump signal having the second polarization and a component S21 of the second pump signal having the first polarization.

The invention is not limited to the embodiments of a method, a device and a station described hereinabove by way of example only, and encompasses any variants thereof that the person skilled in the art may envisage within the scope of the following claims.

1. A method of optically amplifying signals in an optical fiber (3), which method uses stimulated Raman scattering to amplify in said fiber an optical data signal ([λa-λb]) in a selected direction in said optical fiber (3) by means of a first optical pump signal and a second optical pump signal, the pump signals having different wavelengths, which method is characterized in that:
the first optical pump signal comprises two components (S11, S12) having respective and mutually orthogonal first and second polarizations,
the second optical pump signal comprises two components (S21, S22) having the first polarization and the second polarization, respectively, and
a first combined pump signal and a second combined pump signal are injected alternately into the optical fiber, the first combined pump signal comprising a component (S11) of the first pump signal and a component (S22) of the second pump signal that have mutually orthogonal polarizations and the second combined pump signal comprising the other component (S12) of the first pump signal and the other component (S21) of the second pump signal.

2. A method according to claim 1, characterized in that the combined pump signals are injected alternately for substantially equal times.

3. A method according to claim 1, characterized in that the combined pump signals are alternated at a frequency greater than or equal to 1 kHz.

4. A method according to claim 3, characterized in that an alternation frequency of the order of 500 kHz is used.

5. A method according to claim 1, characterized in that said combined pump signals (S11+S22, S12+S21) are contrapropagating with respect to said data signals.

6. A device (D) for amplifying optical data signals, the device being adapted to provide a first pump signal and a second pump signal for amplifying by stimulated Raman scattering a data signal ([λa-λb]) in an optical fiber (3), which device is characterized in that it comprises:
power supply submodules (6, 7) for supplying two components (S11, S12) of the first pump signal having respective and mutually orthogonal first and second polarizations,
power supply submodules (8, 9) for supplying two components (S21, S22) of the second pump signal having the first and second polarizations, respectively, and
a control module (14) adapted to deliver alternately into the optical fiber a first combined pump signal and a second combined pump signal, the first combined pump signal comprising a component (S11) of the first pump signal and a component (S22) of the second pump signal that have mutually orthogonal polarizations and the second combined pump signal comprising the other component (S12) of the first pump signal and the other component (S21) of the second pump signal.

7. A device according to claim 6, characterized in that said control module (14) is adapted to deliver the combined pump signals alternately for substantially equal times.

8. A device according to claim 6, characterized in that said control module (14) is adapted to deliver the combined pump signals alternately at a frequency greater than or equal to 1 kHz.

9. A device according to claim 8, characterized in that said frequency is of the order of 500 kHz.

10. A device according to claim 6, characterized in that it is adapted to deliver combined pump signals (S11+S22, S12+S21) contrapropagating with respect to said data signals.

11. A device according to claim 6, characterized in that it comprises:
a first polarization multiplexer (10) adapted to be supplied continuously by the power supply submodules (6, 7) supplying the two components (S11, S12) of the first pump signal and to combine said components of the first pump signal to deliver one or the other of said components of the first pump signal alternately to an output on the instructions of said control module (14),
a second polarization multiplexer (11) adapted to be supplied continuously by the power supply submodules (8, 9) supplying the two components (S21, S22) of the second pump signal and to combine said components of the second pump signal to deliver one or the other of said components of the second pump signal alternately to an output on the instructions of said control module (14), and
a wavelength division multiplexer (12) adapted to combine the pump signal components delivered to the outputs of said first polarization multiplexer (10) and said second polarization multiplexer (11).

12. A device according to claim 6, characterized in that said power supply module comprises diodes (6-9) adapted to deliver pump signal components having linear polarization.

13. A station (2) for receiving optical signals, comprising a receiver module (5) adapted to be connected to a first end of an optical fiber (3) to receive optical data signals ([λa-λb]) from a sender station (1) connected to a second end of said optical fiber (3), which receiver station (2) is characterized in that it comprises an amplification device (D) according to claim 6.
